(19) United States
(12) Patent Application Publication
(10) Pub. No.: US 2007/0080174 A1
(43) Pub. Date: Apr. 12, 2007

(54) Fluid dispenser with a safety dispensing actuator and fluid dispensing product containing the same

(76) Inventors: Matthew T, Coe, Annandale, NJ (US); Hung Mach, Fort Lee, NJ (US); Mitchell Tung, Bridgewater, NJ (US)

Correspondence Address: Allen R. Kipnes, Esq.;WATOV & KIPNES, P.C., P.O. BOX 247, Princeton Junction, NJ, 08550, US

(21) Appl. No.: 11/418,042

(22) Filed: May 4, 2006

Related U.S. Application Data
(63) Continuation-in-part of application No. 11/245,392, filed on Oct. 6, 2005.

(51) Int. Cl. B67D 5/00; B67D 5/06

(52) U.S. Cl. 222/153.13; 222/184

(57) ABSTRACT

A fluid dispenser includes a pump in. fluid communication with a fluid outlet. The fluid dispenser further includes a securing mechanism for securing the pump to a fluid source containing a fluid, a movable dispensing actuator in operative engagement to the pump where the dispensing actuator is adapted to urge the pump to convey the fluid from the fluid source to the fluid outlet when moved from a first position to a second position, and a rotatable locking mechanism operatively associated with the dispensing actuator for releasable engagement to a fixed portion of the fluid dispenser wherein the dispensing actuator is immobilized in the first position.

### RELATED APPLICATION

This is a Continuation in Part Application of U.S. Ser. No. 11/245,392, filed Oct. 6, 2005.

### FIELD OF THE INVENTION

The present invention relates to fluid dispenser for dispensing a fluid from a container in metered doses, and more particularly to a fluid dispenser having a safety dispensing actuator that substantially reduces the incidence of spillage, contamination, and accidental or inadvertent release of the fluid from a container. The present invention also relates to fluid dispensing products employing the fluid dispenser.

### BACKGROUND OF THE INVENTION

Fluid dispensing products are well known in the art, and may be used to hold a range of fluids (e.g., liquids) including pharmaceuticals, cosmetics, household cleaners, personal care compositions, and foodstuffs. A fluid dispensing product includes a container that can store and dispense quantities of fluid, typically in a metered dose, via a user-actuated fluid dispensing mechanism. A typical fluid dispensing product generally comprises a container or reservoir for holding a fluid, a fluid dispenser having a pump assembly coupled to the container, and a user operable actuator for urging the pump assembly to dispense the fluid from the container in metered doses. Although current fluid dispensing product encompass a range of designs and features, few are designed to prevent spillage, contamination and accidental or inadvertent release of fluids that may be harmful to people.

Accordingly, there is a need for a fluid dispenser for use in a fluid dispensing product that is designed to dispense a metered dose of a fluid such as a liquid in a manner that promotes safe handling and storage, while reducing the incidence of spillage, contamination, accidental and/or inadvertent dispensing of the fluid. There is a further need for a fluid dispenser that is readily operable by those with limited dexterity. Furthermore, there is a need for a fluid dispenser that is simple and cost efficient to make and use.

### SUMMARY OF THE INVENTION

The present invention relates generally to a fluid dispenser for incorporation into a product for dispensing a fluid such as a liquid or semi-solid (e.g., gel) in a manner that promotes or facilitates safe storage and handling of the fluid. The fluid dispenser of the present invention is designed to prevent or at least substantially reduce the incidence of spillage, contamination, or accidental and/or inadvertent release of the fluid. The fluid dispenser of the present invention includes a safety pump assembly and a dispensing actuator designed to be selectively operable by the intended user.

According to the present invention, the safety dispensing actuator operates to effectively prevent unsupervised access to the fluid such as by small children. In addition to providing safety measures, the fluid dispenser is designed to be readily operable by those with limited dexterity such as, for example, elderly users. The fluid dispenser of the present invention can be readily used with minimal or no modifications in existing commercially available dispensing products.

The fluid dispenser of the present invention may be used to dispense any form of fluid including, but not limited to, liquids, semi-solids, solutions, creams, pastes, gels, foams, emulsions, ointments, slurries, and other flowable substances. The present invention is especially suitable for use in dispensing of pharmaceuticals and personal care products.

In one aspect of the present invention, there is provided a fluid dispenser comprising:

dispensing means slidably movable from a standing first position to a second position comprising a dispensing stroke for dispensing a metered dose of a fluid from a fluid source; and

a locking mechanism operatively associated with the dispensing means for immobilizing the dispensing means in the first position, the locking mechanism being movable from a locked position by the user for allowing the dispensing means to move through the dispensing stroke to dispense the fluid, whereby the locking mechanism re-engages into the locked position upon return of the dispensing means to the first position.

In another aspect of the present invention, there is provided a fluid dispensing product comprising:

a fluid dispenser disclosed above; and

a container attached to the fluid dispenser, wherein the container accommodates the fluid source.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a perspective view of a fluid dispensing product in which a fluid dispenser is secured to a container for one embodiment of the present invention;

FIG. 2 is a perspective view of the fluid dispenser shown in FIG. 1;

FIG. 3 is a side elevational view of the fluid dispenser along view lines 3-3 of FIG. 2 in accordance with the present invention;

FIG. 4 is a front elevational view of the fluid dispenser along view lines 4-4 of FIG. 2 in accordance with the present invention;

FIG. 5 is a cross sectional view of the fluid dispenser and container along view lines 5-5 of FIG. 1 in accordance with the present invention;

FIG. 6 is an elevational view of a fluid dispenser secured to a container for a second embodiment of the present invention;

FIG. 7 is a cross sectional view of the fluid dispenser and container of FIG. 6 in accordance with the present invention;

FIG. 8 is a perspective view of-a fluid dispenser with a locking mechanism in the locked position for a third embodiment of the present invention;

FIGS. 9A and 9B each show a perspective view of the fluid dispenser with the locking mechanism rotated into the unlocked positions, respectively, in accordance with the present invention;

FIG. 10 is a perspective view of the fluid dispenser with the dispensing actuator shown at the end of the downward dispensing stroke in accordance with the present invention;

FIG. 11 is an exploded partially cutaway perspective view of the fluid dispenser taken along view lines 11-11 of FIG. 9B in accordance with the present invention; and

FIG. 12 is a cross sectional view of the fluid dispenser taken along view lines 12-12 of FIG. 8, in accordance with the present invention.

### DETAILED DESCRIPTION OF THE INVENTION

The present invention is directed generally to a fluid dispenser designed to be permanently or reversibly secured to a container to yield a fluid dispensing product for dispensing a metered dose of a fluid such as a liquid or a semi-solid stored in the container. The fluid dispenser of the present invention utilizes a manual actuator equipped with a novel safety assembly to provide a secure fluid dispensing product for dispensing the fluid to an intended user. The fluid dispenser of the present invention is designed to promote safe storage and handling of the fluid, while still providing ease of operation for those with limited dexterity such as, for example, elderly users.

The fluid dispenser of the present invention is specifically constructed to prevent or at least substantially reduce the incidence of spillage, contamination, and accidental and/or inadvertent release of the fluid. The fluid dispenser of the present invention is particularly adapted to prevent unsupervised access by small children. Thus, the fluid dispenser of the present invention is especially suited for use in a child-proof fluid dispensing product.

In a general form of the present invention, the fluid dispenser includes dispensing means slidably movable from a standing first position to a second position comprising a dispensing stroke for dispensing a metered dose of a fluid from a fluid source; and a locking mechanism operatively associated with the dispensing means for immobilizing the dispensing means in the first position, said locking mechanism being movable from a locked position by the user for allowing the dispensing means to move through the dispensing stroke to dispense the fluid, whereby the locking mechanism re-engages into the locked position upon return of the dispensing means to the first position.

In a specific form of the present invention, the fluid dispenser includes a pump in fluid communication with a fluid outlet. The fluid dispenser further includes a securing mechanism for securing the pump to a fluid source containing a fluid, a movable dispensing actuator in operative engagement to the pump where the dispensing actuator is adapted to urge the pump to convey the fluid from the fluid source to the fluid outlet when moved from a first position to a second position, and a locking mechanism operatively associated with the dispensing actuator. The locking mechanism of the present invention is configured for releasable engagement to a fixed portion of the fluid dispenser wherein the dispensing actuator is immobilized in the first position to prevent dispensing and thus prevent unauthorized or inadvertent dosing of the fluid.

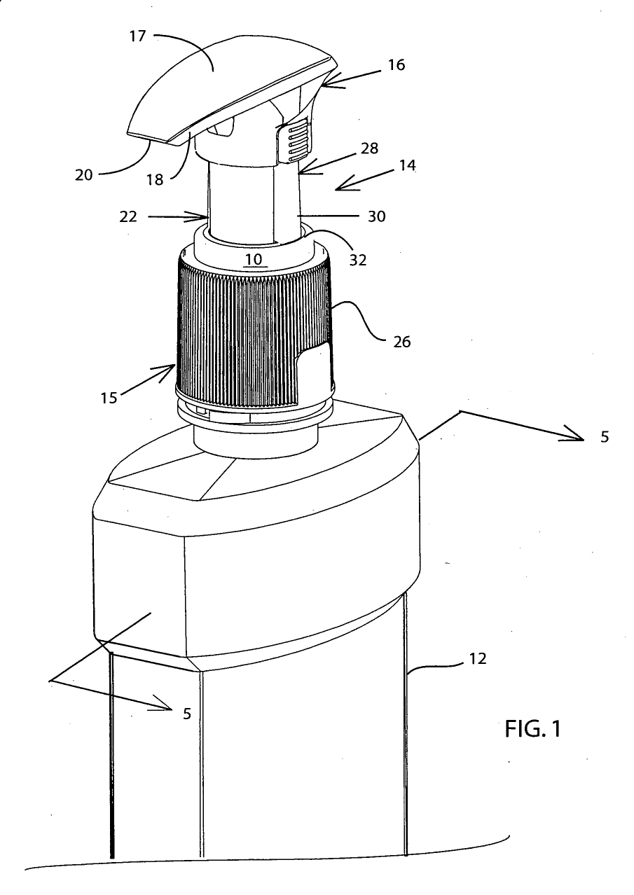

With reference to FIG. 1, there is shown for one embodiment of the present invention a fluid dispenser identified generally by the reference numeral 10 in an operable position engaged to a container 12 to form a fluid dispensing product 13. The fluid dispenser 10 is useful for dispensing dosable fluids including but not limited to medications, vitamins, nutraceuticals, skin care formulations, dental hygiene compositions including mouth rinses, and pharmaceutical compositions, each of which may be in the form of a liquid, semi-solid, solution, cream, paste, gel, foam, ointment, slurry, and other flowable compositions capable of being dispensed in a metered dose from the container 12.

The fluid dispenser 10 is securely attached to the container 12 which is designed to accommodate a quantity of a fluid (not shown) for storage. The fluid dispenser 10 includes a dispensing actuator 14, and a body member 15. The dispensing actuator 14 is adapted for operative engagement with the body member 15. The fluid dispenser 10 operates to draw the fluid in metered amounts from the container 12 for dispensing, upon activation of the dispensing actuator 14 by the user. The dispensing actuator 14 includes a head portion 16 having a contact surface 17, and a spout 18 defining a fluid outlet 20, and a stem portion 22 extending from the head portion 16 to the body member 15. The contact surface 17 is adapted to receive a downward force applied thereon by a user.

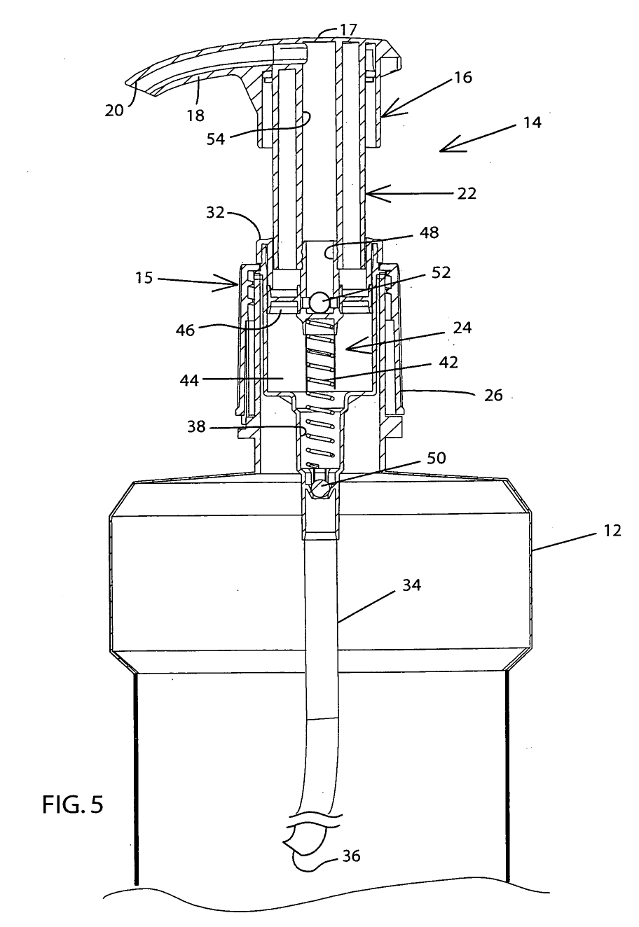

The body member 15 houses a pump 24 described in connection with FIG. 5 hereinafter for moving the fluid from the container 12. The body member 15 further includes a collar 26 for reversibly securing the fluid dispenser 10 to the container 12 via a threaded engagement therebetween to enable the fluid dispenser 10 to be removed from the container 12, thus allowing the container 12 to be refilled and/or the dispenser cleaned. Alternatively, the collar 26 may be irreversibly secured to the container 12. In this embodiment, the fluid dispenser 10 and the container 12, are intended to be discarded when the fluid has been completely discharged from the container 12. Furthermore the preventive measures against accidental or inadvertent release of the fluid and unsupervised access by small children are greatly enhanced when the fluid dispenser 10 and container 12 are permanently secured to each other.

The dispensing actuator 14 is operatively engaged to the body member 15 in association with the pump 24 to urge the fluid out of the fluid dispenser 10. The dispensing actuator 14 moves reciprocally in a sliding action from an upright position to a depressed position. The dispensing actuator 14 is urged to the depressed position by applying a downward force on the contact surface 17 of the head portion 16 to push the stem portion 22 into the body member 15. During the downstroke movement of the dispensing actuator 14, the fluid is dispensed through the fluid outlet 20 by the pump 24 as will be described hereinafter. The dispensing actuator 14 is spring biased upwardly, typically by a spring assembly 42 (See FIG. 5), to rest at the upright position upon releasing the downward force on the contact surface 17.

The fluid dispenser 10 further includes a locking mechanism 28 forming part of the dispensing actuator 14. The locking mechanism 28 is located on opposing sides of the dispensing actuator 14 in the stem portion 22. The locking mechanism 28 releasably locks the dispensing actuator 14 in the upright position during storage or non-use, and thereby prevents the downstroke movement of the actuator 14 that may cause spillage, contamination, and accidental and/or inadvertent release of the fluid until the locking mechanism is released as described hereinafter. The locking mechanism 28 includes a stepped protrusion 30 extending radially outward under the action of a spring (not shown) from the stem portion 22 of the dispensing actuator 14. In a locked position, the stepped protrusion 30 abuts against a shoulder area 32 extending along the top surface of the body member 15, thus effectively preventing the stem portion 22 from moving into the body member 15.

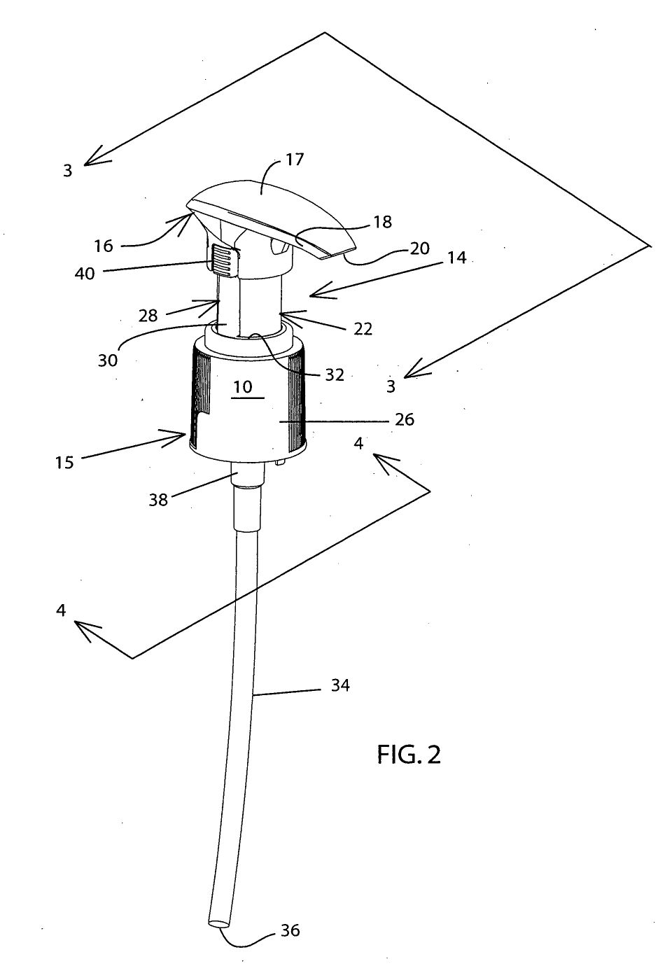

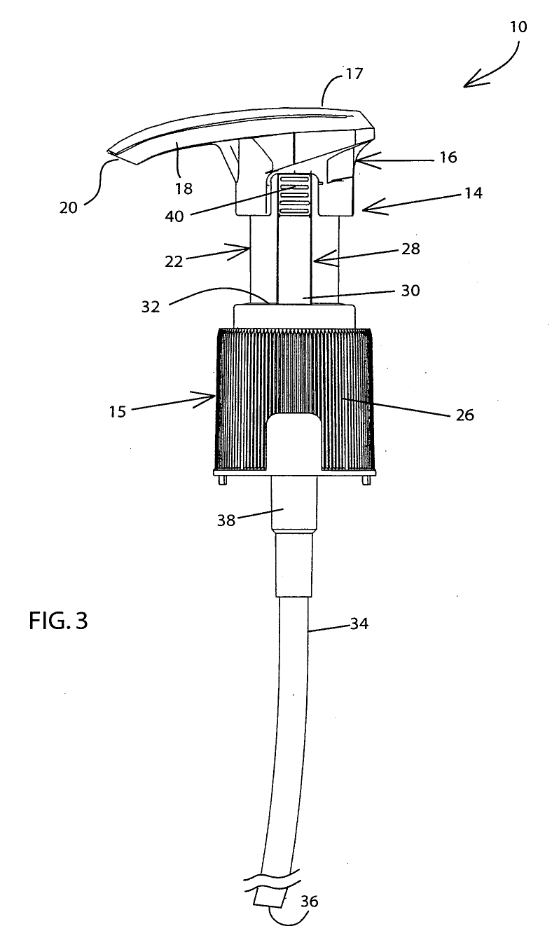

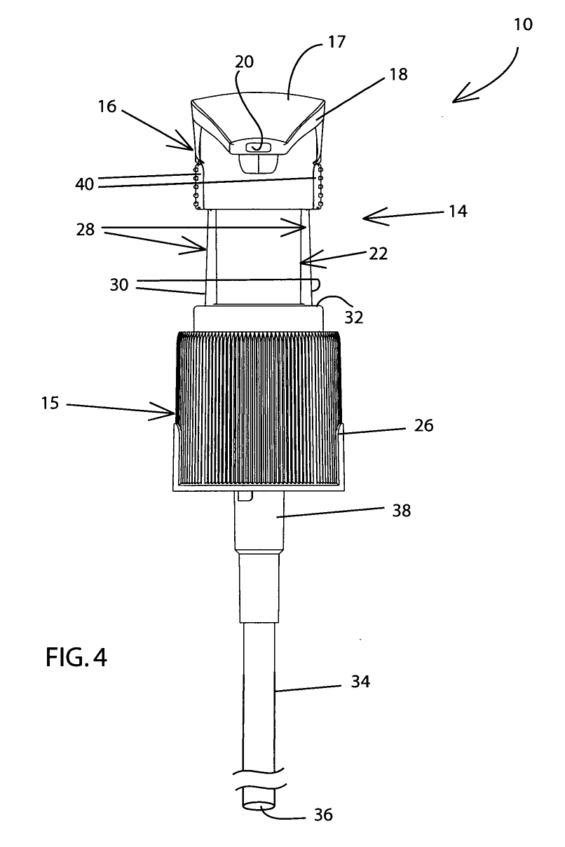

Referring to FIGS. 2 through 4, there is shown the fluid dispenser 10 in a position unsecured from the container 12 for one embodiment of the present invention. The body member 15 further comprises a dip tube 34 with a fluid inlet 36 at the distal end in fluid communication with a pump inlet 38 of the pump 34. The distal end of the dip tube 34 lies below the surface of the fluid within the container 12. During dispensing, the fluid from the container 12 enters the pump 34 via the fluid inlet 36 of the dip tube 34 and the pump inlet 38.

As previously described above, the locking mechanism 28 serves to immobilize the dispensing actuator 14 in the upright position to prevent actuation of the pump 24. The stepped protrusions 30 are resiliently biased radially outward on opposed sides of the stem portion 22 by a spring mechanism (not shown). The locking mechanism 28 further includes a release key 40 located at the upper end of the stepped protrusion 30. The release key 40 is adapted to receive an inwardly directed force applied by the user to thereby move the stepped protrusion 30 radially inward beyond the inner periphery of the shoulder area 32 of the body member 15. This movement provides the dispensing actuator 14 with clearance to move within the body member 15. In this manner, the stepped protrusion 30 can be moved to disengage the locking mechanism 28, thus allowing the dispensing actuator 14 to move freely within the body member 15 and dispense the fluid. Once the locking mechanism 28 is disengaged, the stem portion 22 can slide into the body member 15 to actuate the pump 24 wherein the fluid is correspondingly dispensed through the fluid outlet 20 during the downstroke cycle.

After completion of a downstroke cycle, the dispensing actuator 14 returns to the upright position by the spring assembly 42 (See FIG. 5). In the upright position, the stepped protrusion 30 is urged to a radially outward position by the spring mechanism (not shown) to re-engage the shoulder area 32 of the body member 15 and re-immobilize the dispensing actuator 14 to prevent dispensing during non-use or storage.

Referring to FIG. 5, the pump 24 comprises a pump chamber 44 in fluid communication with the pump inlet 38, a reciprocating pump piston 46 occupying the pump chamber 44, and a pump outlet 48. The pump piston 46 is operatively engaged to the stem portion 22 of the dispensing actuator 14. The pump piston 46 slides reciprocally between a top position and a bottom position within the pump chamber 44 in accordance-with the movement of the dispensing actuator 14. The spring assembly 42 located within the pump inlet 38 is attached to the pump piston 46 to resiliently bias the pump piston 46 in the top position during non-use or storage.

The pump 24 further comprises a first ball check valve 50 located in the pump inlet 38 and a second ball check valve 52 located in the pump outlet 48 to maintain a one-way fluid flow from the fluid inlet 36 to the fluid outlet 20. The pump 24 draws the fluid from the container through the dip tube 34 and the first ball check valve 50 of the pump inlet 38 into the pump chamber 44 during the upstroke cycle of the pump piston 46. The first ball check valve 50 allows the fluid to pass into the pump chamber 44, while preventing backflow of the fluid into the container 12.

The fluid drawn into the pump chamber 44 is pumped through the second ball check valve 52 of the pump outlet 48 during the downstroke cycle of the pump piston 46 by urging the dispensing actuator 14 downwardly. The fluid flows into a dispensing conduit 54 in communication with the fluid outlet 20. The second ball check valve 52 allows the fluid to pass into the dispensing conduit 54 for dispensing through the fluid outlet 20, while preventing backflow of the fluid into the pump chamber 44. At the end of the downstroke cycle, the spring assembly 42 urges the pump piston 46 and the dispensing actuator 14 back to the upright position wherein the pump chamber 44 is correspondingly refilled with the fluid drawn from the container 12 by the vacuum created during the upstroke of the pump piston 46.

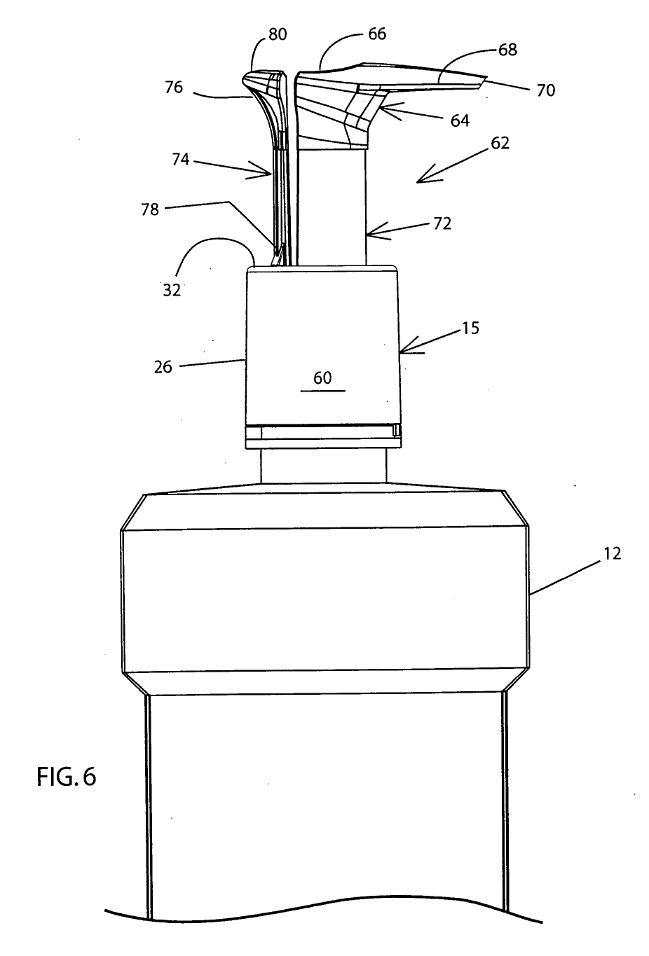

Referring to FIG. 6, a fluid dispenser designated generally by reference numeral 60 is shown in accordance with a second embodiment of the present invention. The fluid dispenser 60 is substantially identical to that shown in FIGS. 1-5 such that like parts will. be identified by like reference numerals. The main difference from the embodiment of FIG. 1 is the form of the dispensing actuator and locking mechanism as will be described hereinafter.

The fluid dispenser 60 includes a dispensing actuator 62 having a head portion 64 with a contact surface 66 and a spout 68 defining a fluid outlet 70, a body member 15, and a stem portion 72 operatively engaged to the body member 15. The dispensing actuator 62 is adapted to move vertically with respect to the body member 15 and operates in substantially the same manner as described in the previous embodiment. The fluid dispenser 60 further includes a locking mechanism 74 comprising a movable release lever 76 for releasably locking the dispensing actuator 62 in the upright position during non-use or storage. The release lever 76 is biased radially outward from the dispensing actuator 62, and includes a lip protrusion 78 at the lower end thereof. When the dispensing actuator 62 is at the upright position, the lip protrusion 78 is operatively engaged to the shoulder area 32 extending along the top surface of the body member 15. This operative engagement effectively immobilizes the dispensing actuator 62 in the upright position, and prevents fluid dispensing that may result in spillage, contamination, or accidental release of the fluid from the container 12.

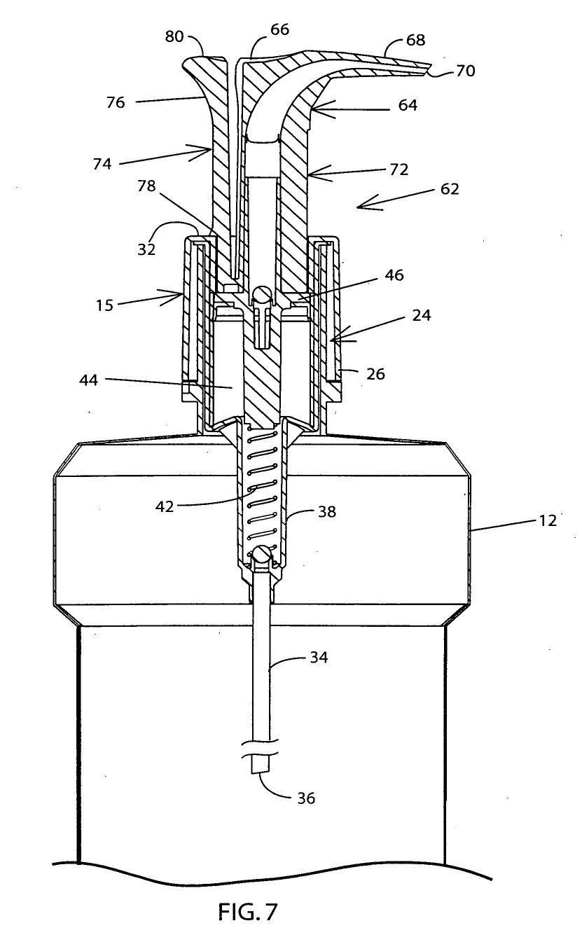

Referring to FIG. 7, the release lever 76 is positioned coextensively in a spaced apart manner with the stem portion 72 of the dispensing actuator 62. This provides the release lever 76 with a degree of movement in the direction of the stem portion 72 of the dispensing actuator 62. The lower end of the release lever 76 is formed integrally with the stem portion 72 of the dispensing actuator 62. The lip protrusion 78 is located proximate to the lower end of the release lever 76 opposite from the stem portion 72 of the dispensing actuator 62. The lip protrusion 78 abuttingly engages the shoulder area 32 of the body member 15 when the dispensing actuator 62 is located in the upright position.

The lip protrusion 78 disengages from the shoulder area 32 upon application of a radially directed inward force on the contact area 80 applied by the user. This applied force moves the release lever 76 toward the dispensing actuator 62 and disengages the lip protrusion 78 from the shoulder area 32. Once the lip protrusion 78 is cleared, the dispensing actuator 62 is free to move downward to the depressed position during which the fluid is dispensed through the fluid outlet 70. When the dispensing actuator 62 returns to the upright position by the spring biased action of the spring assembly 42, the lip protrusion 78 re-engages to and abuts against the shoulder area 32 of the body member 15, thereby automatically re-securing the fluid in the container 12.

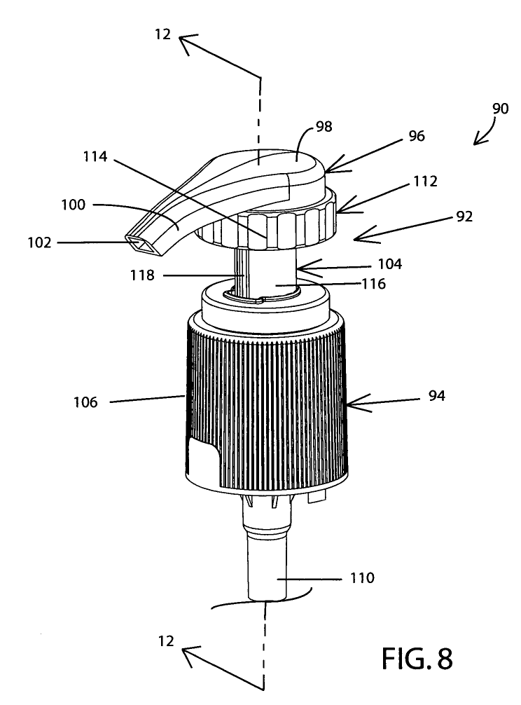

Referring to FIG. 8, there is shown a fluid dispenser identified generally by reference numeral 90 providing a third embodiment of the present invention. The fluid dispenser 90 comprises features similar to those described in the previous embodiments. The fluid dispenser 90 includes a dispensing actuator 92 operatively engaged to a body member 94. The dispensing actuator 92 includes a head portion 96 with a contact area 98, and a spout 100 defining a fluid outlet 102 from which the fluid is dispensed, and a stem portion 104 extending from the head portion 92 to the body member 94.

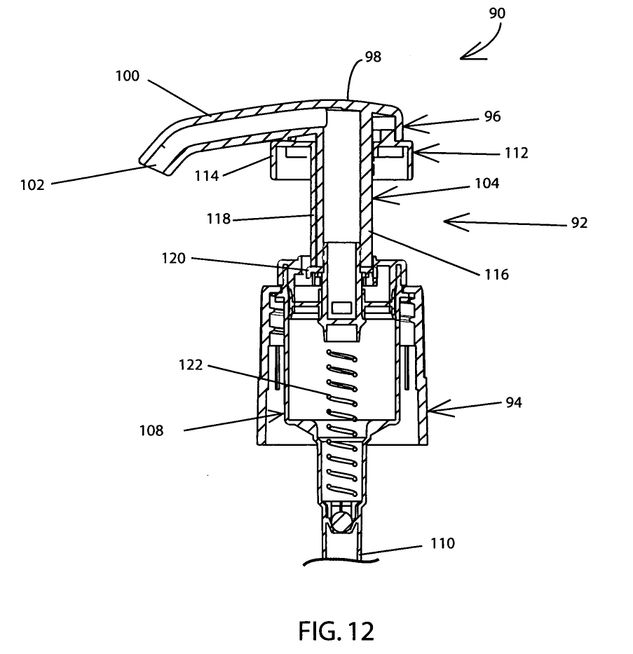

The body member 94 includes a collar 106 for securing the fluid dispenser 90 to a container (not shown) via a threaded engagement therebetween. It is preferable that the fluid dispenser 90 is permanently fixed to the container to prevent accidental or inadvertent release of the fluid by small children or unintended users. The body member 94 further includes a pump assembly 108 (as shown best in FIG. 12) for moving the fluid from the container through a dip tube 110. The components and operation of the pump assembly 108 are substantially the same as described above in previous embodiments.

The dispensing actuator 92 is operatively engaged to the body member 94 in association with the pump assembly 108 to urge the fluid out of the fluid dispenser 10. The dispensing actuator 92 moves reciprocally in a sliding action from an upright position to a depressed position. The dispensing actuator 92 is urged to the depressed position by applying a downward force on the contact surface 98 of the head portion 96 to push the stem portion 104 into the body member 94. During the downstroke movement of the dispensing actuator 92, the fluid is dispensed through the fluid outlet 102 by the pump assembly 108.

The fluid dispenser 90 further includes a rotatable locking mechanism 112 forming part of the dispensing actuator 92. The rotatable locking mechanism 112 is configured to rotate independently about the head and stem portions 96 and 104. The rotatable locking mechanism 114 includes a knob 112, a cylindrical portion 116, and a projection 118 extending longitudinally along the surface of the cylindrical portion 116 between the knob 114 and the body member 94. The projection 118 of the rotatable locking mechanism 112 is normally spring-biased into a locking position. In the locked position, the projection 118 engages a stop 120 located in the body member 94 (as shown best in FIG. 12). The engagement between the projection 118 and the stop 120 immobilizes the dispensing actuator 92, thereby preventing dispensing of the fluid.

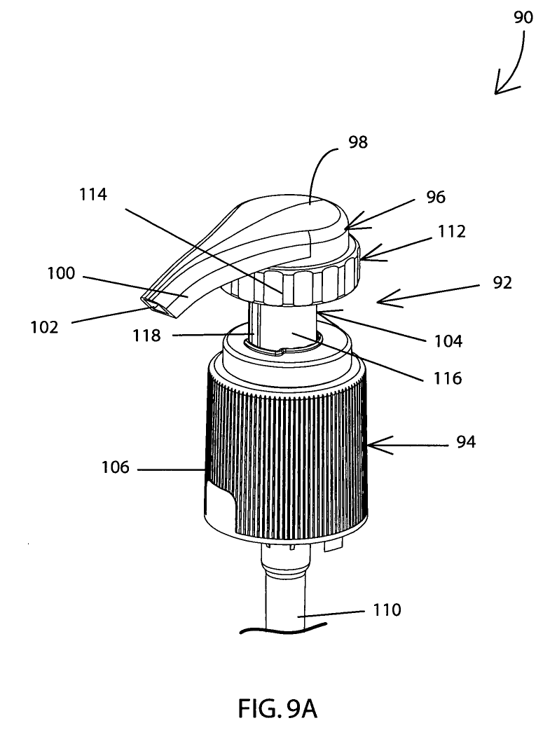

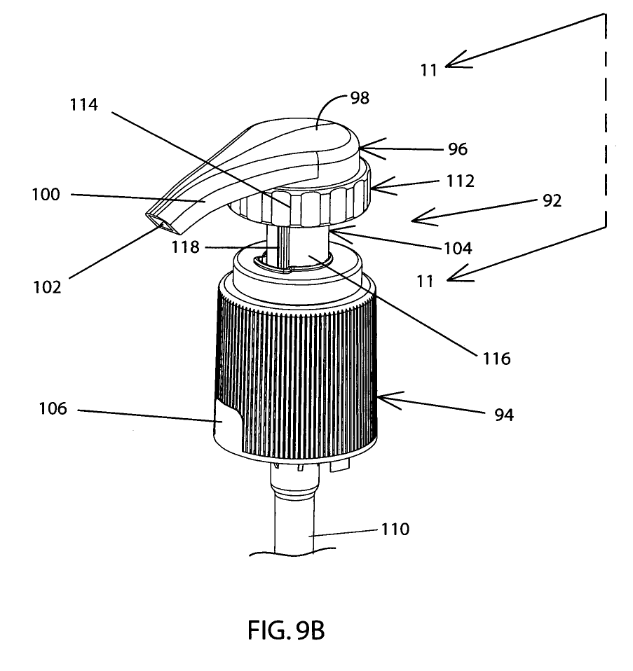

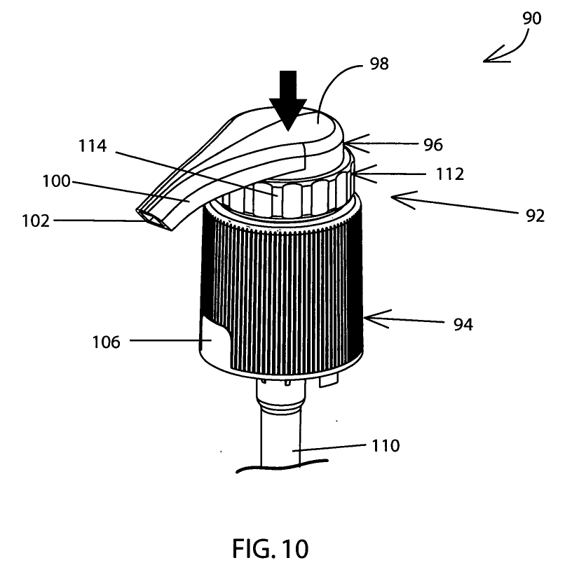

Referring to FIGS. 9A and 9B, the rotatable locking mechanism 112 can be easily unlocked. The knob 114 can be turned or rotated by a preset amount in the clock-wise direction (as shown in FIG. 9A) or in the counterclockwise direction (as shown in FIG. 9B) to disengage the locking mechanism 112. The turning action of the knob 114 moves the projection 118 from the locked position, and disengages the projection 118 from the stop 120. Once the projection 118 is cleared from the stop 120, the dispensing actuator 92 can be pressed downward (See FIG. 10), whereby the fluid is dispensed therefrom.

Upon release, the dispensing actuator 92 is returns to the initial position by a spring 122 in the pump assembly 108 (as shown best in FIG. 12). The rotatable locking mechanism 112 is spring-biased as previously noted, and the projection 118 automatically returns to the locked position, where the projection 118 re-engages the stop 120 to prevent further dispensing.

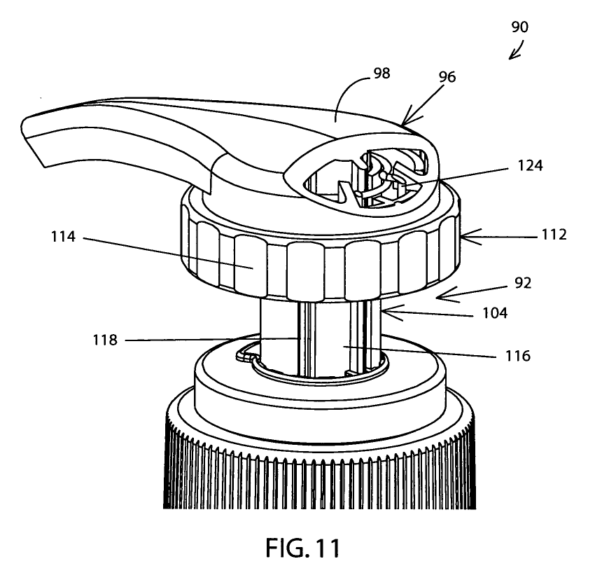

Referring to FIG. 11, the dispensing actuator 92 of the fluid dispenser 90 is shown from a rear perspective view along view lines 11-11 of FIG. 9B. The dispensing actuator 92 is shown with an exterior portion partially cutaway to view the interior thereof. As shown, the rotatable locking mechanism 112 is maintained in the normally locked position by a torque spring 124 disposed in the dispensing actuator 92. The torque spring 124 is configured to bring the locking mechanism 112 back to the lock position from the exerted clockwise or counterclockwise turn after the user releases the knob 114. In this manner, the rotatable locking mechanism 112 return projection 118 to the locked state, and prevent any subsequent inadvertent dispensing.

Referring to FIG. 12, the dispensing actuator 92 is spring biased upwardly, typically by the spring 122, to rest at the upright position upon releasing the downward force on the contact surface 98. The fluid dispenser 90 is shown in a locked position with the projection 118 abutting against the stop 120 of the body member 94 to prevent movement of the dispensing actuator 92. The stop 120 is disposed proximate the stem portion 104 of the dispensing actuator 92.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A fluid dispenser comprising:
dispensing means slidably movable from a standing first position to a second position comprising a dispensing stroke for dispensing a metered dose of a fluid from a fluid source; and
a locking mechanism operatively associated with the dispensing means for immobilizing the dispensing means in the first position, said locking mechanism being movable from a locked position by the user for allowing the dispensing means to move through the dispensing stroke to dispense the fluid, whereby the locking mechanism re-engages into the locked position upon return of the dispensing means to the first position.

2. The fluid dispenser of claim 1 wherein said dispensing means further comprises:
a pump in communication with a fluid outlet for dispensing the fluid therethrough; and
an actuator movable with the dispensing means between the first and second positions, said actuator being operatively engaged to the pump for urging the pump to draw the fluid from the fluid source to the fluid outlet, during the dispensing stroke.

3. The fluid dispenser of claim 2 wherein the locking mechanism is adapted to engage a stationary portion relative to the movable dispensing means in the locked position to prevent movement of the actuator.

4. The fluid dispenser of claim 3 wherein the locking mechanism is rotatably movable from the locked position to disengage from the stationary portion.

5. The fluid dispenser of claim 4 wherein the locking mechanism comprises:
a substantially cylindrical member movable with the actuator, said cylindrical member further being rotatable between the locked and unsecured positions;
a knob disposed at the proximal end of the cylindrical member, said knob being configured to enable the user to rotate the cylindrical member to the unsecured position; and
a projection extending longitudinally along the length of the cylindrical member between the knob and the distal end of the cylindrical member, said projection abutting the stationary portion and immobilizing the actuator in the first position, when the cylindrical member is at the locked position, wherein the rotation of the cylindrical member to an unsecured position disengages the projection from the stationary portion and permit movement of the actuator.

6. The fluid dispenser of claim 3 wherein the locking mechanism is radially movable from the locked position to disengage from the stationary portion.

7. The fluid dispenser of claim 6 wherein the locking mechanism comprises:
at least one stepped protrusion movable with the actuator, said stepped protrusion further being displaceable between the locked and unsecured positions; and
an end portion of the stepped protrusion abutting the stationary portion and immobilizing the actuator in the first position, when the stepped protrusion is at the locked position, wherein the displacement of the stepped protrusion to an unsecured position disengages the end portion from the stationary portion and permit movement of the actuator.

8. The fluid dispenser of claim 1 further comprising means for securing the fluid dispenser to the fluid source.

9. The fluid dispenser of claim 8 wherein the securing means comprises a collar member adapted for threaded coupling to a corresponding threaded portion of the fluid source.

10. The fluid dispenser of claim 9 wherein the fluid source is a container.

11. A fluid dispensing product comprising:
a fluid dispenser of claim 1; and
a container attached to the fluid dispenser, wherein said container accommodates the fluid source.

12. The fluid dispensing product of claim 11 wherein said dispensing means further comprises:
a pump in communication with a fluid outlet for dispensing the fluid therethrough; and
an actuator movable with the dispensing means between the first and second positions, said actuator being operatively engaged to the pump for urging the pump to draw the fluid from the fluid source to the fluid outlet, during the dispensing stroke.

13. The fluid dispensing product of claim 12 wherein the locking mechanism is adapted to engage a stationary portion relative to the movable dispensing means in the locked position to prevent movement of the actuator.

14. The fluid dispensing product of claim 13 wherein the locking mechanism is rotatably movable from the locked position to disengage from the stationary portion.

15. The fluid dispensing product of claim 14 wherein the locking mechanism comprises:
a substantially cylindrical member movable with the actuator, said cylindrical member further being rotatable between the locked and unsecured positions;
a knob disposed at the proximal end of the cylindrical member, said knob being configured to enable the user to rotate the cylindrical member to the unsecured position; and
a projection extending longitudinally along the length of the cylindrical member between the knob and the distal end of the cylindrical member, said projection abutting the stationary portion and immobilizing the actuator in the first position, when the cylindrical member is at the locked position, wherein the rotation of the cylindrical member to an unsecured position disengages the projection from the stationary portion and permit movement of the actuator.

16. The fluid dispensing product of claim 13 wherein the locking mechanism is radially movable from the locked position to disengage from the stationary portion.

17. The fluid dispensing product of claim 16 wherein the locking mechanism comprises:
at least one stepped protrusion movable with the actuator, said stepped protrusion further being displaceable between the locked and unsecured positions; and
an end portion of the stepped protrusion abutting the stationary portion and immobilizing the actuator in the first position, when the stepped protrusion is at the locked position, wherein the displacement of the stepped protrusion to an unsecured position disengages the end portion from the stationary portion and permit movement of the actuator.
